(19) United States
(12) Patent Application Publication
(10) Pub. No.: US 2010/0154601 A1
(43) Pub. Date: Jun. 24, 2010

(54) ERGONOMIC TOOL HANDLE

(75) Inventor: BRENT CHRISTOPHER, PORTLAND, OR (US)

Correspondence Address: SHUTTLEWORTH & INGERSOLL, P.L.C., 115 3RD STREET SE, SUITE 500, P.O. BOX 2107, CEDAR RAPIDS, IA, 52406, US

(73) Assignee: MERIDIAN INTERNATIONAL CO., LTD., SHANGHAI (CN)

(21) Appl. No.: 12/486,021

(22) Filed: Jun. 17, 2009

(30) Foreign Application Priority Data
Dec. 22, 2008 (CN) 200820157529.4

(51) Int. Cl. B25B 13/46; B25B 23/16

(52) U.S. Cl. 81/60; 81/177.1

(57) ABSTRACT

A handle body for a ratcheting tool has an ergonomic shape adapted to receive the palm of a user's hand. The handle has an elongated inner core with an outwardly extending midportion. The core is surrounded by an encasing having a substantially convex profile which slopes downward toward the ratcheting mechanism. Substantially near the apex of the protruded midportion is an orifice for receiving a torsion bar to provide more torque. The handle further has a female end opposite the ratcheting mechanism end for extending the length of the tool.

### PRIORITY CLAIM

The present application claims priority under 35 USC §119 to Chinese application 200820157529.4 filed Dec. 22, 2008, which is incorporated herein by reference.

### TECHNICAL FIELD

The present disclosure relates to an improved ergonomic handle for increasing the applied torque to a ratcheting mechanism. More specifically, the disclosure relates to a handle body adapted to receive force from a user's palm.

### BACKGROUND INFORMATION

Ratcheting drivers have been in existence for many years. These drivers include screwdrivers, nut drivers, ratchets and the like. Improvements in drivers have created tools able to deliver more torque than past devices. However, improvements in handle bodies have not kept up with the advances in ratcheting mechanisms.

Previous palm-type drivers, both ratcheting and non-ratcheting, have been provided. Such drivers generally included a drive member having an axis of rotation and adapted to be engaged with an associated driven member, such as a fastener or the like, for rotating it. The drive member is coupled to a handle which is adapted to be received, in use, in the palm of a user's hand. Such handles have heretofore taken a number of different shapes. One standard type of tool has an elongated handle which crosses the axis of the drive member to define a generally T-shaped tool. Another type of handle is shaped as a knob and adaptable for gripping by a user's hand. This type of tool is disclosed in U.S. Pat. No. 6,079,298. While the '298 patent seeks to provide a comfortable handle able to receive increased leverage, this handle body requires the user use his wrist in a rotating motion to operate the device. Wrist rotation is insufficient to meet the high amount of force current ratcheting drivers are able to deliver.

While such prior handle shapes have functioned acceptably, they have generally been uncomfortable, particularly in cases of extended use. The T-shaped tools do not fit easily into a user's palm and, while knob handles generally fit better in the palm of the hand, they afford less leverage.

Accordingly, there is a need for a ratcheting device with an ergonomic handle adapted to receive force from a user's palm.

### SUMMARY

In accordance with one aspect of the disclosure, a handle body for a ratcheting tool has an ergonomic shape for receiving the palm of a user's hand. The handle is comprised of an elongated inner core with a protruded midportion. The core is surrounded by an encasing having a substantially convex profile which slopes downward toward the ratcheting mechanism. Substantially near the apex of the protruded midportion is an orifice for receiving a torsion bar to provide more torque. The handle further has a female end opposite the ratcheting mechanism end for extending the length of the tool.

### BRIEF DESCRIPTION OF THE DRAWINGS

These and other features and advantages of the present invention will be better understood by reading the following detailed description, taken together with the drawings wherein:

FIG. 1 is an isometric view of the handle body with a ratcheting mechanism, viewing the handle body from the ratchet end;

FIG. 2 is an isometric view of the handle body with a ratcheting mechanism, viewing the handle body from the user's end;

FIG. 3 is an isometric view of the core of the handle body; and

FIG. 4 is a side elevational view of a portion of a ratcheting mechanism.

### DETAILED DESCRIPTION OF THE PREFERRED EMBODIMENTS

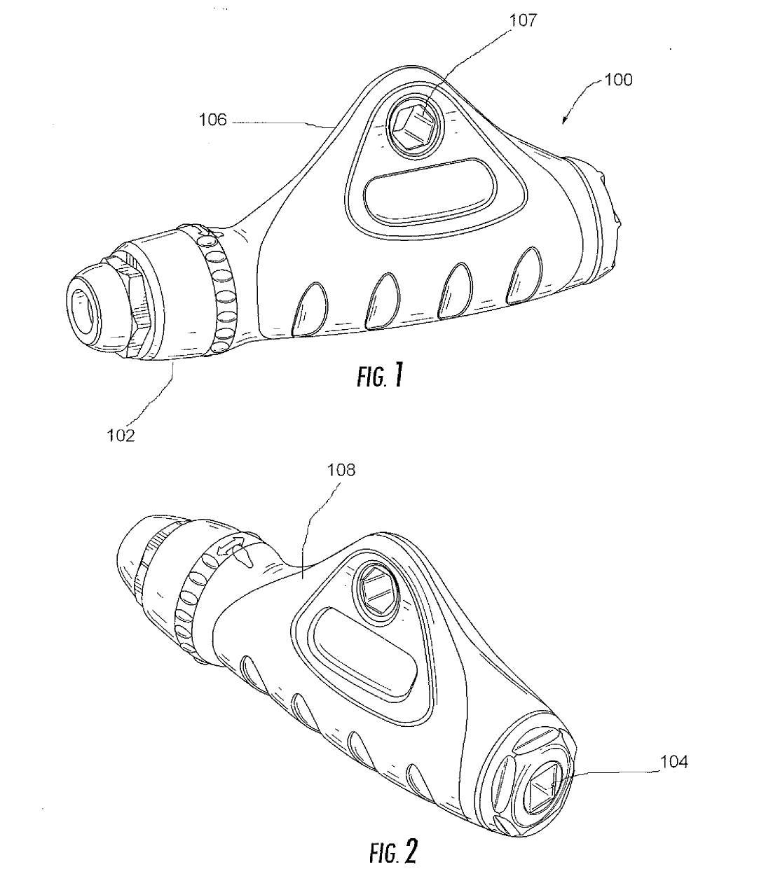

Referring to FIGS. 1-3, there is illustrated a palm driver generally designated by the numeral 100. The driver 100 with ratcheting mechanism 102 is comprised of a core 110 surrounded by an ergonomic encasing 106.

The core 110 is preferably made of steel or a steel composite material such as zinc alloy and is generally T-shaped. The core 110, in an embodiment, is surrounded by an encasing 106. Therefore, the core is preferably shaped to readily allow for a molding to be formed around it. Ridges on the core 110 allow for surfaces for which the molding can affix. The core 110 is T-shaped and therefore has an outwardly extending mid-portion which gives the driver mechanism 100 its unique shape. In an embodiment, the mid-portion has an orifice 107 at its outer end. Orifice 107 is designed to receive a torsion bar or an alternative leverage bar (not shown). The user inserts the bar through the orifice 107 which creates a lever. As is well known in mechanics, using a leverage bar reduces the amount of work needed to turn the driver. This is especially advantageous for hard to remove fasteners.

The core 110 also provides a female end 104 adapted to receive an extension bar (not shown). In an embodiment, the female end 104 is adapted to receive either a ⅜″ or ¼″ square extension, however, one skilled in the art would easily recognize the female end can be formed to receive any number of sizes. Driver 100 with the extension bar allows the user to increase the length of the driver 100 by fixing the bar into the female end 104.

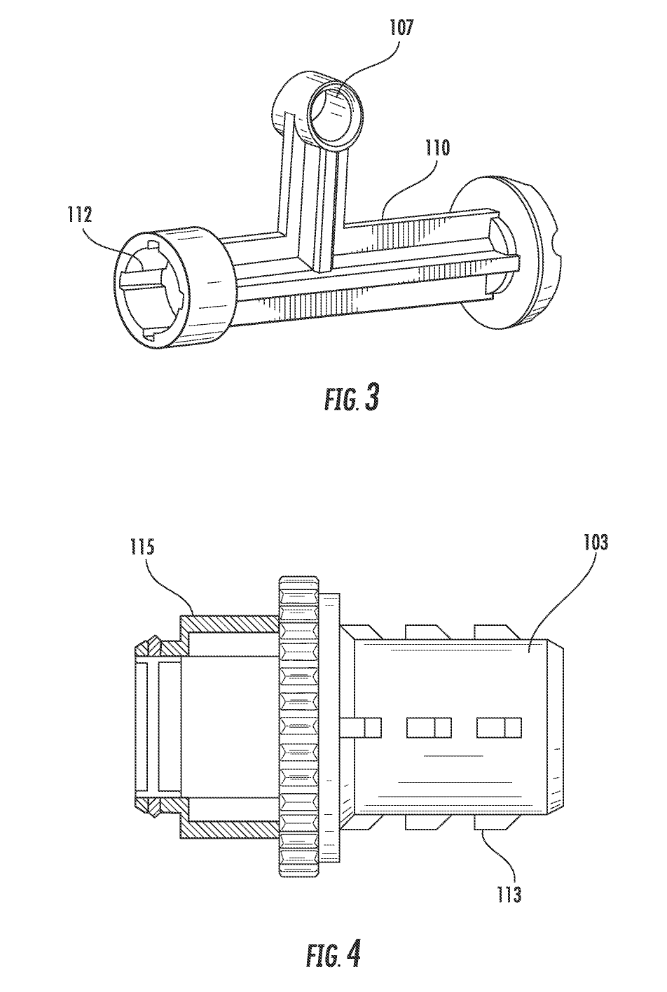

The other end of the core 110 provides a receptacle 112 for receiving a ratcheting mechanism 102. A portion 115 of a typical ratcheting mechanism 102 is shown in FIG. 4. The portion 115 has an engagement end 103 which securely fastens the ratcheting mechanism 102 inside the receptacle 112 of the core 110. In an embodiment, the engagement end 103 is formed with four rows of linear teeth 113 adapted to engage within the receptacle 112 of the core 110 and therefore fasten the ratcheting mechanism to the core 110. The teeth 113 securely fix the ratcheting mechanism 102 with the core 110. One skilled in the art would recognize that any means of securing the main body to the handle body may be employed. For example, the engagement end 113 of the ratcheting mechanism 102 could be threaded.

An ergonomic encasing 106 is manufactured around the core 110. In an embodiment, the encasing 106 is shaped to receive the palm of the user's hand. The encasing 106 of the core 110 is generally cylindrical, but is formed to encompass the upwardly extending mid-portion of the core 110. This creates a substantially convex profile having a peak that gradually slopes downward toward the end containing the ratcheting mechanism 102 and the female end 104. In an embodiment, the encasing 106 is made from plastic, however, any type of material is sufficient and meant to be encompassed by this disclosure.

This formation creates an ergonomic profile especially comfortable for the palm of the user's hand. More specifically, the side surfaces of the encasing 106 are shaped to fit generally the palm of the user's hand or that portion of the hand which extends from the base of the fingers to above the wrist. This novel design allows the user to apply more rotational force to the driver than otherwise possible by merely gripping and turning with the wrist.

In another aspect of an embodiment, the encasing 106 is provided with a cushioning grip in the form of a sheath 108 of a suitable elastomeric material or rubber to provide increased comfort and improved grip. Preferably, the sheath 108 is of substantially uniform thickness over most of its area, this thickness being substantially equal to the height of raised indicia (if any), so that the tops of those indicia are exposed. The sheath 108 may be molded over the encasing 106 or, alternatively, could be secured in place by a suitable adhesive.

While, in the illustrated embodiment, the driver is a ratcheting driver, it will be appreciated that the principles of the invention are equally applicable to non-ratcheting drivers. Furthermore, while an embodiment discloses a specific shape and material, it should be appreciated that other materials or variations in shape could be utilized while still achieving the advantages of the invention.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

We claim:

1. A handle for a tool having a ratcheting mechanism at one end, the handle having an ergonomic shape adapted for receiving a palm of a user's hand, the handle comprising:
an elongated core having an outwardly extending midportion; and
an encasing having a substantially convex profile which slopes downward from said apex of said midportion toward the end containing the ratcheting mechanism.

2. The handle of claim 1 comprising an orifice substantially near the apex of said midportion.

3. The handle of claim 1 comprising a female engagement end opposite of the ratcheting mechanism end.

4. The handle of claim 1 having an outer frictional sheath attached to said encasing.

5. A palm engaging handle for a ratcheting mechanism comprising:
a handle body having opposed first and second ends and an outwardly extending midportion;
said first end is coupled to said ratcheting mechanism; and
wherein said protruded portion is adapted to receive an external force applied from a user's palm.

6. The driver of claim 5 further comprising an orifice through said midportion, said orifice adapted to receive a torsion bar wherein the user inserts said torsion bar to increase torque.

7. The driver of claim 5 wherein said second end comprises a female engagement end adapted to receive an attachment.

8. The driver of claim 5 wherein said handle body further comprises an outer sheath, wherein said sheath provides a frictional surface to engage the user's palm.

9. A handle for a tool having a ratcheting mechanism at one end, the handle having an ergonomic shape adapted for receiving a palm of a user's hand, the handle comprising:
an elongated core having an outwardly extending midportion with an orifice at the end and opposed receptacle and female attachment ends; and
an encasing surrounding said core, wherein said encasing slopes downward from said midportion toward the ratcheting mechanism end.

10. The handle of claim 9 having an outer frictional sheath attached to said encasing.
